(19) United States
(12) Patent Application Publication
(10) Pub. No.: US 2026/0179997 A1
(43) Pub. Date: Jun. 25, 2026

(54) Folding Apparatus for Terrace, Battery Cell and Manufacturing Method Thereof

(71) Applicant: SK On Co., Ltd., Seoul (KR)

(72) Inventors: Seung Hyeon CHEON, Daejeon (KR); Eun Soo CHO, Daejeon (KR); Jun Hui JEONG, Daejeon (KR)

(21) Appl. No.: 19/424,394

(22) Filed: Dec. 18, 2025

(30) Foreign Application Priority Data
Dec. 23, 2024 (KR) 10-2024-0194503

(51) Int. Cl. H01M 10/04; H01M 50/105

(52) U.S. Cl. CPC H01M 10/0404; H01M 50/105

(57) ABSTRACT

A folding apparatus for a terrace of a cell case is disclosed. In some implementations, the apparatus includes: a stripper including an upper stripper and a lower stripper disposed to face each other to support both sides of the terrace of the cell case; a lower mold for supporting the terrace; and an upper mold for folding the terrace to form a folded portion on the terrace, wherein the upper mold enters a folding space formed between the lower mold and the lower stripper to fold the terrace.

### CROSS-REFERENCE TO RELATED APPLICATION(S)

This patent document claims the priority and benefits of Korean Patent Application No. 10-2024-0194503 filed on December 23, 2024, the disclosure of which is incorporated herein by reference in its entirety.

### TECHNICAL FIELD

The disclosure and implementations disclosed in this patent document generally relate to a folding apparatus for a terrace for folding a terrace of a secondary battery cell capable of being charged and discharged, a secondary battery cell and a manufacturing method of a secondary battery cell.

### BACKGROUND

Unlike a primary battery, a secondary battery cell has convenience, in that the secondary battery cell is chargeable and dischargeable, and therefore has been spotlighted as a power source for various mobile devices, electric vehicles, energy storage systems, and the like.

The secondary battery cell may be manufactured as a pouch-type cell or a can-type cell. The pouch-type cell has an electrode assembly accommodated inside a flexible cell case (pouch). The can-type cell has an electrode assembly accommodated inside a rigid cell case (can), and may be configured as a cylindrical cell, a prismatic cell, a coin cell, or the like.

The cell case of the pouch-type cell may include an electrode accommodating portion for accommodating the electrode assembly and a terrace disposed at least on a portion of a circumference of the electrode accommodating portion and extending outwardly from the electrode accommodating portion. At least a partial region of the terrace may be thermally fused (pressed) to form a sealing portion. The sealing portion may seal the electrode accommodating portion from the outside.

### SUMMARY

To prevent external moisture from penetrating into the battery cell, a width of a sealing portion formed on a terrace is required to be secured to be greater than or equal to a predetermined distance. When the width of the sealing portion is increased, a volume of the battery cell may increase. To enhance bonding reliability of the sealed sealing portion and to reduce a volume occupied by the terrace, the terrace may undergo a folding processing to form a folded portion on the terrace. To fold the terrace, a jig and/or a roller may be used.

The folding processing may be sequentially performed through a first folding process of folding the terrace at a first angle (e.g., 180 degrees) and a second folding process of folding the terrace at a second angle (e.g., 270 degrees).

When folding the terrace by using a roller, a cycle time may be shortened, as compared with a case of using a jig. However, during a process in which the terrace is folded by the roller, a meandering phenomenon may occur. To reduce the meandering phenomenon, a process of forming a pre-folding line serving as a folding reference on the terrace may be performed before folding at a predetermined angle. In addition, a heat pressing process or a sizing process of additionally pressing the folded portion may be performed to prevent the folded portion from being unfolded by spring-back.

An aspect of the present disclosure may provide a folding apparatus for a terrace, a battery cell and a manufacturing method thereof, in which a process of forming the folded portion is simplified and productivity is improved.

An aspect of the present disclosure may provide a folding apparatus for a terrace, a battery cell and a manufacturing method thereof, in which the folded portion may be easily formed.

An aspect of the present disclosure may provide a folding apparatus for a terrace, a battery cell and a manufacturing method thereof, in which equipment for the folding processing is simple and equipment cost is reduced.

The present disclosure may be implemented in some embodiments to provide a folding apparatus for a terrace, a manufacturing method thereof, and a battery cell manufactured thereby, which may be widely applied to green technology fields such as electric vehicles, battery charging stations, solar power generation, wind power generation, and the like using batteries. In addition, the folding apparatus for a terrace, the manufacturing method thereof, and the battery cell manufactured thereby according to the present disclosure may be used for eco-friendly electric vehicles (EVs) and hybrid vehicles, which reduce air pollution and greenhouse gas emissions to prevent climate change.

In some embodiments of the present disclosure, a folding apparatus for a terrace of a cell case includes: a stripper including an upper stripper and a lower stripper disposed to face each other to support both sides of the terrace of the cell case; a lower mold for supporting the terrace; and an upper mold for folding the terrace to form a folded portion on the terrace, wherein the upper mold enters a folding space formed between the lower mold and the lower stripper to fold the terrace.

The lower mold is structured to move toward the lower stripper to press the folded portion formed on the terrace by the upper mold.

The terrace may extend from an electrode accommodating portion of the cell case in a first direction, and the lower mold may be structured to move in the first direction to press the folded portion.

A total angle of the terrace folded by the upper mold may be 180 degrees or more.

The upper mold may include a folding forming portion in contact with the terrace for folding the terrace, and the folding forming portion may have a shape whose width becomes narrower toward a lower side.

The upper mold may be structured to enter the folding space by moving in a second direction, which is a thickness direction of the cell case.

The upper mold may enter the folding space by moving in a direction inclined relative to a second direction, which is a thickness direction of the cell case. Here, a first side surface of the lower stripper and a second side surface of the lower mold, which face each other, may respectively include inclined surfaces inclined relative to the second direction, and at least one of an inclination angle of the first side surface of the lower stripper and an inclination angle of the second side surface of the lower mold may have the same value as an inclination angle formed by a moving direction of the upper mold.

The folding apparatus may further include a heater for heating the lower mold.

In some embodiments of the present disclosure, a manufacturing method of a battery cell includes: preparing a cell for folding including a sealing portion formed on a terrace; disposing the terrace of the cell for folding on a lower mold; supporting both sides of the terrace by a lower stripper and an upper stripper; and performing a folding process of pressing the terrace by using an upper mold to form a folded portion on the terrace, wherein in the folding process, the terrace is folded by causing the upper mold to enter a folding space formed between the lower mold and the lower stripper.

The manufacturing method may further include a pressing process of moving the lower mold toward the lower stripper to press the folded portion formed on the terrace.

In the folding process, the upper mold may enter the folding space by moving in a second direction, which is a thickness direction of the cell for folding.

In the folding process, the upper mold may enter the folding space by moving in a direction inclined relative to a second direction, which is a thickness direction of the cell for folding.

The pressing process may be performed while the lower mold is heated.

In some embodiments of the present disclosure, a battery cell includes: an electrode assembly; and a cell case including an electrode accommodating portion accommodating the electrode assembly and a terrace disposed on at least a portion of a circumference of the electrode accommodating portion and extending outwardly from the electrode accommodating portion, wherein at least a portion of the terrace includes a folded portion, the folded portion includes a first portion in which the terrace extends from the electrode accommodating portion in a first direction, a second portion connected to the first portion and bent to form a first angle relative to the first portion, and a third portion connected to the second portion and bent to form a second angle relative to the second portion, and the third portion is disposed outside the second portion.

The first angle may have a value of 75 degrees or more and 105 degrees or less.

The second angle may have a value of 150 degrees or more and 180 degrees or less.

A length of the third portion may be greater than a length of the second portion.

### BRIEF DESCRIPTION OF DRAWINGS

Certain aspects, features, and advantages of the present disclosure are illustrated by the following detailed description with reference to the accompanying drawings.

FIG. 1 is a plan view of a cell for folding according to an embodiment.

FIG. 2 is a cross-sectional view taken along line I-I’ of FIG. 1.

FIG. 3 is a perspective view of a battery cell according to an embodiment.

FIG. 4 is a cross-sectional view taken along line II-II’ of FIG. 3.

FIG. 5 is a cross-sectional view of a modified embodiment of the battery cell illustrated in FIG. 4.

FIG. 6 is a cross-sectional view of another modified embodiment of the battery cell illustrated in FIG. 4.

FIG. 7A is a cross-sectional view of a shape of the cell for folding.

FIG. 7B is a cross-sectional view of the battery cell according to an inventive example (embodiment).

FIG. 7C is a cross-sectional view of a battery cell according to a comparative example.

FIG. 8 is a schematic view of a folding apparatus for a terrace according to an embodiment.

FIGS. 9A through 9G are schematic views sequentially illustrating a process of folding a terrace by using the folding apparatus for a terrace illustrated in FIG. 8.

FIG. 10 is a schematic view of a folding apparatus for a terrace according to another embodiment.

FIG. 11 is a flowchart illustrating a manufacturing method of a battery cell according to an embodiment.

### DETAILED DESCRIPTION

Features of the present disclosure disclosed in this patent document are described by example embodiments with reference to the accompanying drawings.

The present disclosure may be implemented in some embodiments to provide a folding apparatus for a terrace, a battery cell and a manufacturing method thereof.

In the specification, the same reference numerals or signs described or illustrated in the accompanying drawings denote parts or components that perform substantially the same functions. For convenience of description and understanding, the same reference numerals or signs may be used for description even in different embodiments. That is, even if components having the same reference numerals are illustrated in the plurality of drawings, the plurality of drawings do not necessarily refer to one embodiment.

In the following description, a term of a singular number includes its plural number unless clearly indicated otherwise in the context. Terms such as “include” or “comprise” are intended to specify the presence of features, numbers, steps, operations, components, parts, or combinations thereof described in the specification, and are not intended to preclude the possibility of presence or addition of one or more other features, numbers, steps, operations, components, parts, or combinations thereof.

In addition, in the following description, expressions such as upper side, upper portion, lower side, lower portion, side, front, and rear are expressed based on the directions illustrated in the drawings, and it is previously stated that such an expression may be expressed differently if a direction of the corresponding subject is changed.

In addition, in the following description and claims, terms including ordinals such as “first” and “second” may be used for distinction among components. Such ordinals are used to distinguish the same or similar components from each other, and should not be construed to limit meanings of terms due to the use of such ordinals. For example, components coupled with such ordinals should not be construed to be limited in use order or arrangement order by the numerals. If necessary, the respective ordinals may be interchanged and used.

Hereinafter, the present disclosure is described in detail with reference to the drawings. However, the present disclosure is merely illustrative, and is not limited to the specific embodiments illustratively described.

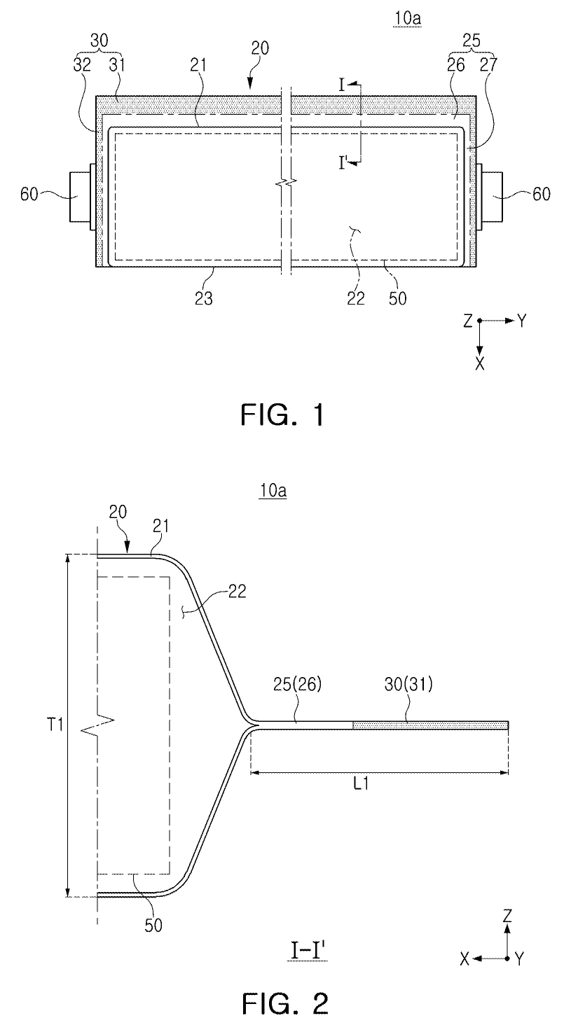

FIG. 1 is a plan view of a cell 10a for folding according to an embodiment, and FIG. 2 is a cross-sectional view taken along line I-I’ of FIG. 1.

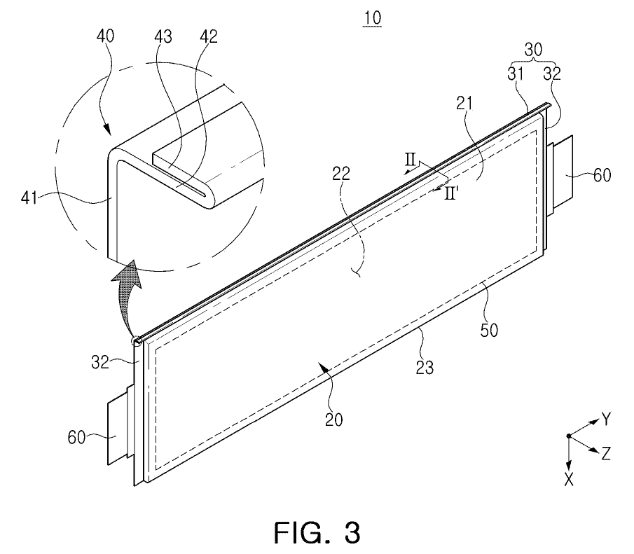

FIGS. 1 and 2 illustrate the cell 10a for folding before a folding processing is performed, and a battery cell 10 according to the present disclosure (see FIG. 3) may be formed by performing the folding processing on a terrace 25 of the cell 10a for folding.

Referring to FIGS. 1 and 2, the cell 10a for folding may include an electrode assembly 50, an electrode lead 60, and a cell case 20.

The electrode assembly 50 may include a plurality of positive electrodes, a plurality of negative electrodes, and a plurality of separators. The separator may be disposed between the positive electrode and the negative electrode. The plurality of positive electrodes, the plurality of negative electrodes, and the plurality of separators may be arranged to form a plurality of layers.

The electrode lead 60 may be electrically connected to the electrode assembly 50, and a portion thereof may be exposed outward from the cell case 20. The electrode lead 60 may include a positive electrode lead electrically connected to the positive electrode and a negative electrode lead electrically connected to the negative electrode. The electrode leads 60 may respectively be disposed on both sides of the cell case 20. For example, the positive electrode lead and the negative electrode lead may be exposed in different directions from the cell case 20. However, the arrangement and number of the electrode leads 60 may be variously modified. For example, the electrode leads 60 may all be disposed on one side of the cell case 20. In addition, the electrode leads 60 may include a plurality of positive electrode leads and a plurality of negative electrode leads.

The cell case 20 may include an electrode accommodating portion 21 accommodating the electrode assembly 50 and the terrace 25 disposed on at least a portion of a circumference of the electrode accommodating portion 21 and extending outwardly from the electrode accommodating portion 21. The electrode accommodating portion 21 may include an accommodating space 22 for accommodating the electrode assembly 50 therein.

The terrace 25 may have a flange shape extending outwardly from the electrode accommodating portion 21. At least a partial region of the terrace 25 may be thermally fused (pressed) to form a sealing portion 30. The sealing portion 30 may seal the electrode accommodating portion 21 from the outside. A width of the sealing portion 30 formed on the terrace 25 may be set to prevent external moisture from penetrating into the battery cell 10.

The terrace 25 may include a first terrace 26 positioned on a surface where the electrode lead 60 is not disposed, and a second terrace 27 positioned on a surface where the electrode lead 60 is disposed.

The sealing portion 30 may include a first sealing portion 31 formed on the first terrace 26 on which the electrode lead 60 is not disposed, and a second sealing portion 32 formed on the second terrace 27 on which the electrode lead 60 is disposed. When the electrode accommodating portion 21 is formed by folding a single sheet of outer material (e.g., a pouch film), three of four sides of the electrode accommodating portion 21 may have an open shape, and one side 23 may be closed. The sealing portion 30 may be formed on the terrace 25 corresponding to the three open sides of the electrode accommodating portion 21.

The cell case 20 may have a predetermined thickness T1, and the terrace 25 may have a predetermined length L1. The length L1 of the terrace 25, the thickness T1 of the cell case 20, a position of the region where the sealing portion 30 is formed on the terrace 25, and/or the width of the sealing portion 30 may be variously modified.

However, the battery cell 10 (see FIG. 3) or the cell 10a for folding according to the present disclosure is not limited to the sealing portion 30 formed on three sides of the electrode accommodating portion 21. For example, the cell 10a for folding may have the electrode accommodating portion 21 formed by overlapping two outer materials. In this case, the sealing portion 30 may be formed on all four sides of the electrode accommodating portion 21.

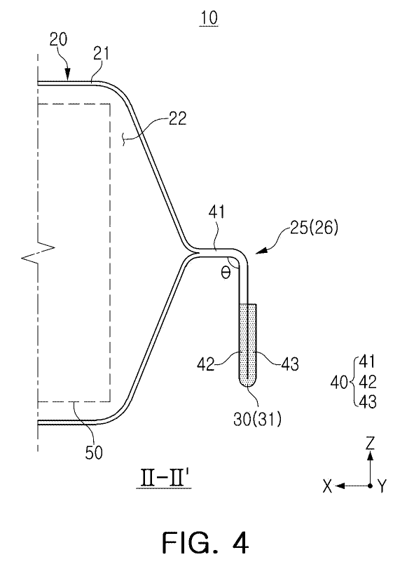

FIG. 3 is a perspective view of the battery cell 10 according to an embodiment, and FIG. 4 is a cross-sectional view taken along line II-II’ of FIG. 3.

Referring to FIGS. 3 and 4, the battery cell 10 according to an embodiment of the present disclosure may include the electrode assembly 50, and the cell case 20 including the electrode accommodating portion 21 accommodating the electrode assembly 50, and the terrace 25 disposed on at least a portion of the circumference of the electrode accommodating portion 21 and extending outwardly from the electrode accommodating portion 21. At least a portion of the terrace 25 may include a folded portion 40. The terrace 25 may be folded to form the folded portion 40. The folded portion 40 may include a first portion 41 in which the terrace 25 extends from the electrode accommodating portion 21 in a first direction X, a second portion 42 connected to the first portion 41 and bent to form a first angle θ relative to the first portion 41, and a third portion 43 connected to the second portion 42 and bent to form a second angle relative to the second portion 42. The third portion 43 may be disposed outside the second portion 42.

The battery cell 10 according to the present disclosure may have the folded portion 40 formed on the terrace 25 of the cell 10a for folding illustrated in FIGS. 1 and 2.

The battery cell 10 may include the electrode assembly 50, the electrode lead 60, and the cell case 20. The description provided with reference to FIGS. 1 and 2 may also be applied to the electrode assembly 50 and the electrode lead 60 illustrated in FIGS. 3 and 4.

The cell case 20 may include the electrode accommodating portion 21 accommodating the electrode assembly 50, and the terrace 25 disposed on at least a portion of the circumference of the electrode accommodating portion 21 and extending outwardly from the electrode accommodating portion 21. At least a partial region of the terrace 25 may be thermally fused (pressed) to form the sealing portion 30. The terrace 25 may include the first terrace 26 positioned on the surface where the electrode lead 60 is not disposed, and the second terrace 27 positioned on the surface where the electrode lead 60 is disposed. The sealing portion 30 may include the first sealing portion 31 formed on the first terrace 26 on which the electrode lead 60 is not disposed, and the second sealing portion 32 formed on the second terrace 27 on which the electrode lead 60 is disposed. The descriptions provided with reference to FIGS. 1 and 2 may also be applied to the sealing portion 30 of the electrode accommodating portion 21 and the terrace 25 illustrated in FIGS. 3 and 4.

At least a portion of the terrace 25 may be folded to form the folded portion 40. The folded portion 40 may be formed by bending the first terrace 26 where the electrode lead 60 is not disposed. The folded portion 40 may be formed to enhance bonding reliability of the sealed sealing portion 30 and to reduce a volume occupied by the terrace 25. The folded portion 40 may include the first portion 41, the second portion 42, and the third portion 43.

The first portion 41 may include a portion in which the terrace 25 extends from the electrode accommodating portion 21 in the first direction X. In the present disclosure, the first direction X may be defined as a direction parallel to a direction in which the first terrace 26 positioned on the surface where the electrode lead 60 is not disposed extends from the electrode accommodating portion 21. In addition, in the present disclosure, the first direction X is defined to include both +X-axis and −X-axis directions relative to a coordinate axis. The first portion 41 of the first terrace 26 may have the same shape as the terrace 25 before the folded portion 40 is formed.

The second portion 42 may be connected to the first portion 41 and bent to form the first angle θ relative to the first portion 41. The second portion 42 may have a bent shape relative to a boundary with the first portion 41. The first angle θ may be defined as an inner angle between the first portion 41 and the second portion 42. The second portion 42 may have a bent shape in a first rotational direction (e.g., a clockwise direction) relative to the boundary between the first portion 41 and the second portion 42.

The first angle θ may have a value of 75 degrees or more and 105 degrees or less. For example, as illustrated in FIG. 4, the first angle θ may be 90 degrees, and is not limited thereto.

The third portion 43 may be connected to the second portion 42 and bent to form the second angle relative to the second portion 42. The third portion 43 may have a bent shape relative to a boundary with the second portion 42. The second angle may be defined as an inner angle between the second portion 42 and the third portion 43. The third portion 43 may have a bent shape in a second rotational direction (e.g., a counterclockwise direction) relative to the boundary between the second portion 42 and the third portion 43.

The second angle may have a value of 150 degrees or more and 180 degrees or less. For example, the second angle may be 180 degrees. When the second angle is 180 degrees, the second portion 42 and the third portion 43 may be disposed to be parallel to each other.

The third portion 43 may be disposed outside the second portion 42. The second portion 42 may be positioned between the first portion 41 and the third portion 43. The third portion 43 may be positioned on an opposite side of the electrode accommodating portion 21 relative to the second portion 42. The rotational direction (e.g., counterclockwise) in which the third portion 43 is bent may be opposite to the rotational direction (e.g., clockwise) in which the second portion 42 is bent.

At least a portion of the second portion 42 and at least a portion of the third portion 43 may include the sealing portion 30. Each of the second portion 42 and the third portion 43 included in the folded portion 40 may include the first sealing portion 31 where the electrode lead 60 is not disposed.

The sum of lengths of the first portion 41, the second portion 42, and the third portion 43 may be equal to the length L1 of the terrace 25 before the folded portion 40 (see FIG. 2) is formed.

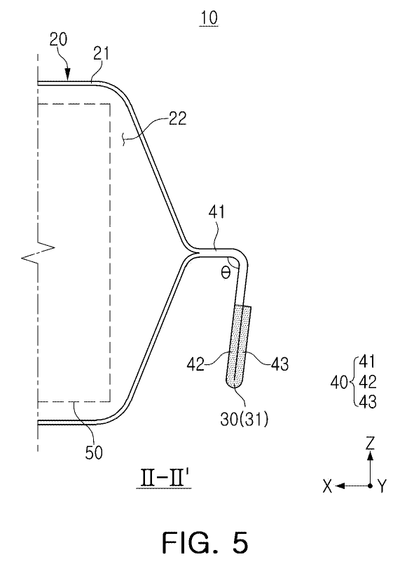

FIG. 5 is a cross-sectional view of a modified embodiment of the battery cell 10 illustrated in FIG. 4.

Compared with the battery cell 10 illustrated in FIG. 4, the battery cell 10 illustrated in FIG. 5 differs in that the first angle θ between the first portion 41 and the second portion 42 has a smaller value. Except for the differences, the descriptions provided with reference to FIGS. 3 and 4 may also be applied to FIG. 5.

Referring to FIG. 5, the folded portion 40 may include the first portion 41, the second portion 42, and the third portion 43, and the third portion 43 may be disposed outside the second portion 42.

The first angle θ between the first portion 41 and the second portion 42 may have a value less than 90 degrees. That is, the second portion 42 may be bent by 90 degrees or more relative to a boundary with the first portion 41.

In an embodiment illustrated in FIG. 5, the first angle θ between the first portion 41 and the second portion 42 may be less than 90 degrees, and the folded portion 40 may thus be prevented or restricted from being unfolded due to a spring-back phenomenon.

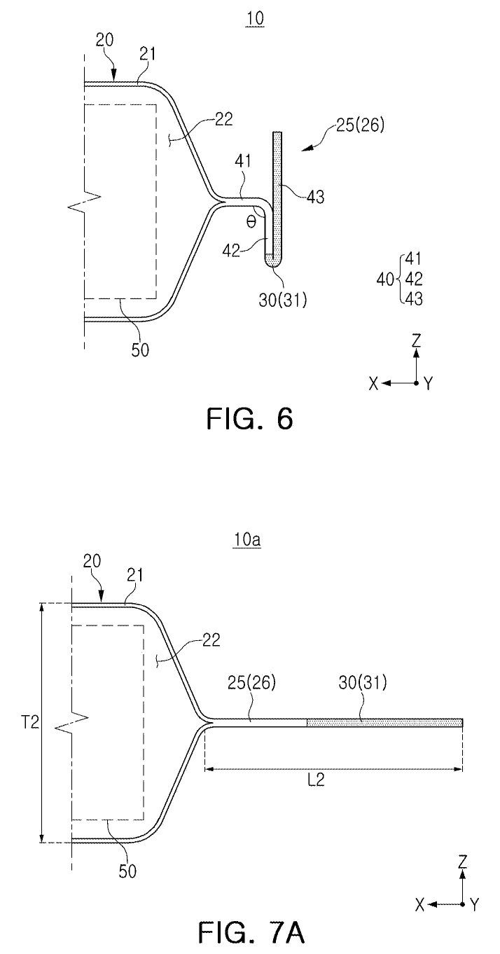

FIG. 6 is a cross-sectional view of another modified embodiment of the battery cell 10 illustrated in FIG. 4.

Compared with the battery cell 10 illustrated in FIG. 4, the battery cell 10 illustrated in FIG. 6 differs in that a length of the third portion 43 is greater than a length of the second portion 42. Except for the differences, the descriptions provided with reference to FIGS. 3 and 4 may also be applied to FIG. 6.

Referring to FIG. 6, the folded portion 40 may include the first portion 41, the second portion 42, and the third portion 43, and the third portion 43 may be disposed outside the second portion 42.

In an embodiment illustrated in FIGS. 3 and 4, the third portion 43 may be formed to be shorter than the second portion 42, whereas in an embodiment illustrated in FIG. 6, the length of the third portion 43 may be greater than the length of the second portion 42.

The third portion 43 may be disposed outside the second portion 42, and the third portion 43 may thus be formed to have a length greater than that of the second portion 42. The third portion 43 may extend beyond a boundary between the first portion 41 and the second portion 42.

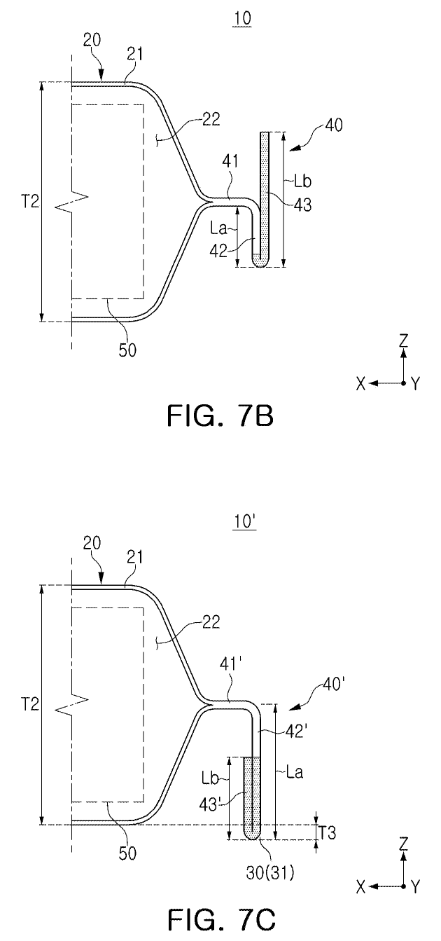

According to an embodiment, even when a thickness of the cell case 20 is small and a length of the terrace 25 is relatively great, the folded portion 40 may not exceed the thickness of the cell case 20. This configuration is described with reference to FIGS. 7A to 7C.

FIG. 7A is a cross-sectional view of the shape of the cell 10a for folding, FIG. 7B is a cross-sectional view of the battery cell 10 according to an inventive example (embodiment), and FIG. 7C is a cross-sectional view of the battery cell 10’ according to a comparative example. FIG. 7A illustrates a shape of the cell 10a for folding before the folding of the battery cell 10 illustrated in FIG. 6, and the battery cell 10 illustrated in FIG. 7B has the same shape as that of the battery cell 10 illustrated in FIG. 6.

In the cell 10a for folding illustrated in FIG. 7A, a thickness T2 of the cell case 20 may be smaller than the thickness T1 of the cell case 20 illustrated in FIG. 2. In the cell 10a for folding illustrated in FIG. 7A, a length L2 of the terrace 25 may have a value similar to the length L1 of the terrace 25 illustrated in FIG. 2. A width of the sealing portion 30 formed on the terrace 25 may be set to prevent external moisture from penetrating into the battery cell 10, and the length of the terrace 25 may thus be maintained at a predetermined level even when the thickness of the cell case 20 decreases.

Referring to FIG. 7B, in the folded portion 40 of the battery cell 10 according to an inventive example (embodiment), a length Lb of the third portion 43 may have a value greater than a length La of the second portion 42.

The first portion 41 may extend from a central portion of the electrode accommodating portion 21 based on the thickness T2 of the cell case 20.

The third portion 43 may be disposed outside the second portion 42, and the length Lb of the third portion 43 may thus be formed to be greater than the length La of the second portion 42. The third portion 43 may extend beyond a boundary between the first portion 41 and the second portion 42. That is, the third portion 43 may extend across the central portion of the electrode accommodating portion 21 based on the thickness T2 of the cell case 20.

The third portion 43 may be disposed outside the second portion 42, and the length Lb of the third portion 43 may thus extend within a range of the thickness T2 of the cell case 20 when the thickness T2 of the cell case 20 is small.

In contrast, in a folded portion 40’ of the battery cell 10’ illustrated in FIG. 7C, which illustrates the comparative example, a second portion 42’ may be bent from a first portion 41’, and a third portion 43’ may be bent from the second portion 42’. The third portion 43’ may be disposed inside the second portion 42’. That is, the third portion 43’ may be positioned between the second portion 42’ and the electrode accommodating portion 21.

In the comparative example illustrated in FIG. 7C, the third portion 43’ may be positioned inside the second portion 42’, and a length Lb of the third portion 43’ is thus required to have a value less than a length La of the second portion 42’. Therefore, when the thickness T2 of the cell case 20 is small, a portion of the folded portion 40’ may extend beyond a thickness range of the cell case 20 in a thickness direction of the cell case 20. For example, a portion of the third portion 43’ may extend beyond the thickness range of the cell case 20 and be exposed outward from the cell case 20 by a protrusion size T3.

Therefore, the battery cell 10’ according to the comparative example has a limitation in forming the thickness T2 of the cell case 20 to be small.

In contrast, according to the inventive example (embodiment) illustrated in FIG. 7B, the length Lb of the third portion 43 may be formed to be greater than the length La of the second portion 42, and thus the folded portion 40 may be easily formed even in the battery cell 10 including the cell case 20 having a small thickness T2.

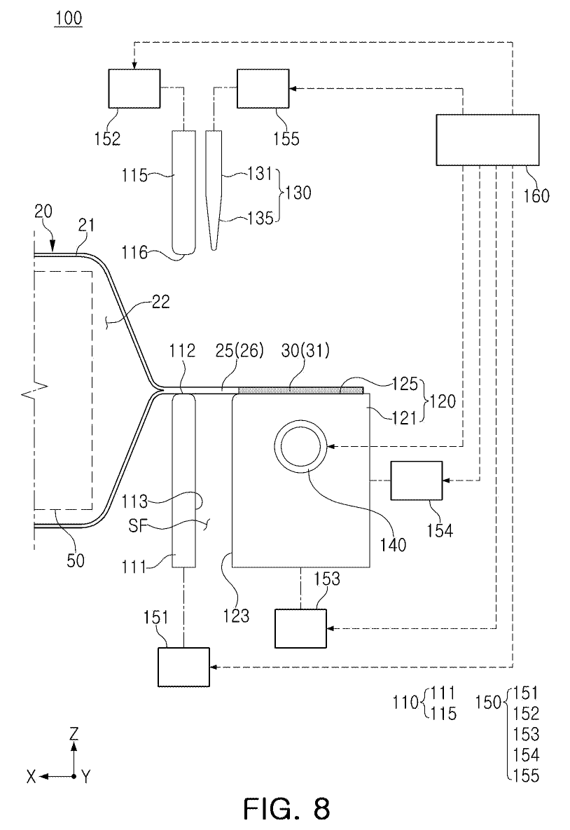

FIG. 8 is a schematic view of a folding apparatus 100 for a terrace according to an embodiment.

Referring to FIG. 8 together with FIGS. 1 through 4, the folding apparatus 100 for a terrace according to the present disclosure may fold the terrace 25 of the cell 10a for folding to form the folded portion 40 on the terrace 25.

The folding apparatus 100 for a terrace of a cell case 20 according to an embodiment may include: a stripper 110 including an upper stripper 115 and a lower stripper 111 disposed to face each other to support both sides of the terrace 25 of the cell case 20; a lower mold 120 for supporting the terrace 25; and an upper mold 130 for folding the terrace 25 to form the folded portion 40 on the terrace 25. The upper mold 130 may enter a folding space SF formed between the lower mold 120 and the lower stripper 111 to fold the terrace 25. The folding apparatus 100 for a terrace according to an embodiment may further include a driving unit 150 for moving at least some of the lower mold 120, the upper mold 130, the upper stripper 115, and the lower stripper 111.

The stripper 110 may support the terrace 25 of the cell case 20 from both the sides. The stripper 110 may support an inner portion of the terrace 25. The stripper 110 may be disposed at a position adjacent to the electrode accommodating portion 21 of the cell case 20.

The stripper 110 may include the upper stripper 115 and the lower stripper 111 disposed opposite to each other on both the sides of the terrace 25. The lower stripper 111 may include a first contact surface 112 in contact with a lower surface of the terrace 25, and the upper stripper 115 may include a second contact surface 116 in contact with an upper surface of the terrace 25. The upper stripper 115 and the lower stripper 111 may press the terrace 25 by a predetermined pressure to prevent movement of the terrace 25 during the folding processing. Although FIG. 8 illustrates that the first contact surface 112 of the lower stripper 111 and the second contact surface 116 of the upper stripper 115 have the same width, the widths of the first contact surface 112 and the second contact surface 116 may be variously modified.

The lower mold 120 may support the terrace 25. The lower mold 120 may include a body 121 and a support surface 125 for supporting the terrace 25. The terrace 25 may be disposed on the support surface 125 of the lower mold 120 during the folding processing.

The folding space SF may be formed between the lower mold 120 and the lower stripper 111. The folding space SF may be formed between a first side surface 113 of the lower stripper 111 and a second side surface 123 of the lower mold 120. The first side surface 113 of the lower stripper 111 and the second side surface 123 of the lower mold 120 may face each other while having the folding space SF interposed therebetween.

The upper mold 130 may fold the terrace 25 to form the folded portion 40 on the terrace 25. The terrace 25 may include the first terrace 26 positioned on the surface where the electrode lead 60 is not disposed, and the folded portion 40 may be formed on the first terrace 26. The upper mold 130 may enter the folding space SF formed between the lower mold 120 and the lower stripper 111 to fold the terrace 25.

The upper mold 130 may include a folding forming portion 135 in contact with the terrace 25 for folding the terrace 25, and the folding forming portion 135 may have a shape whose width becomes narrower toward a lower side.

The folding forming portion 135 may press the terrace 25 to bend the terrace 25 while the terrace 25 moves into the folding space SF. To easily bend the terrace 25 in the folding space SF, the upper mold 130 may allow the folding forming portion 135 positioned on the lower side to have a width narrower than a width of a body 131 positioned on an upper side. The folding forming portion 135 may have a width narrower on the lower side than on the upper side. The folding forming portion 135 may have a width that becomes narrower from the upper side toward the lower side.

The upper mold 130 may be structured to enter the folding space SF by moving in a second direction Z, which is the thickness direction of the cell case 20. For example, the upper mold 130 may enter the folding space SF by moving in a direction perpendicular to the terrace 25.

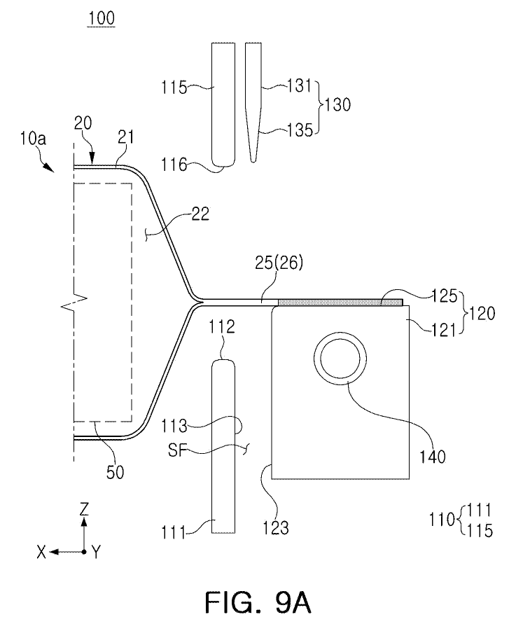

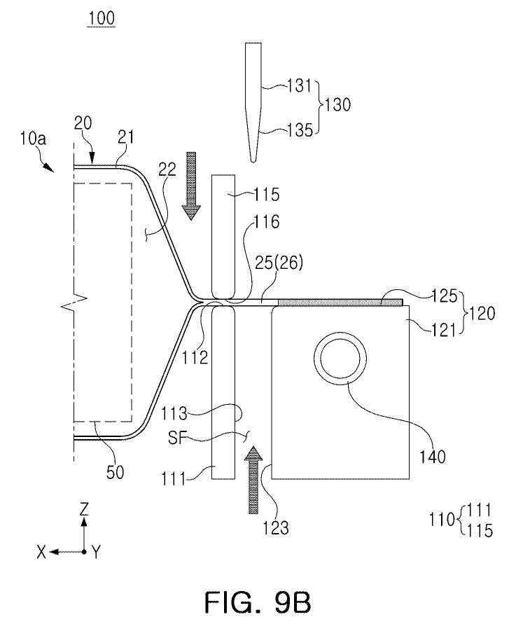

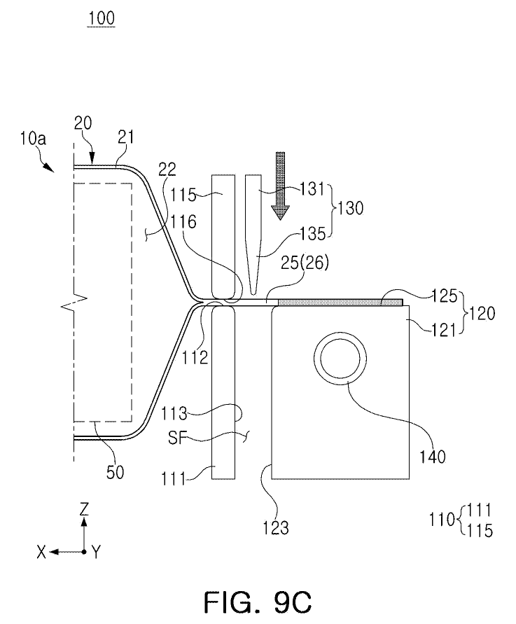

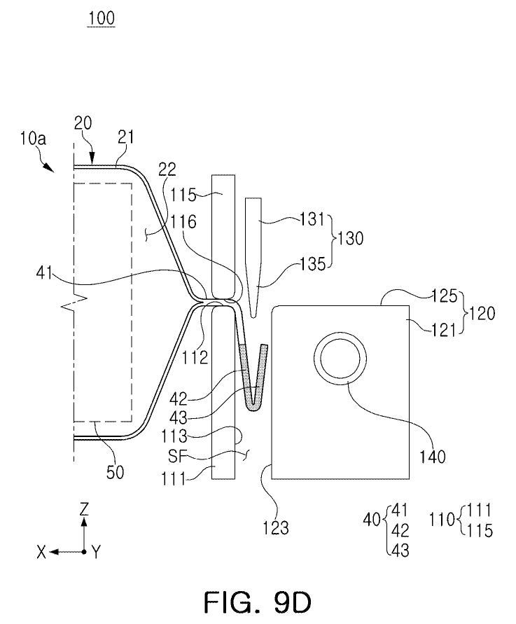

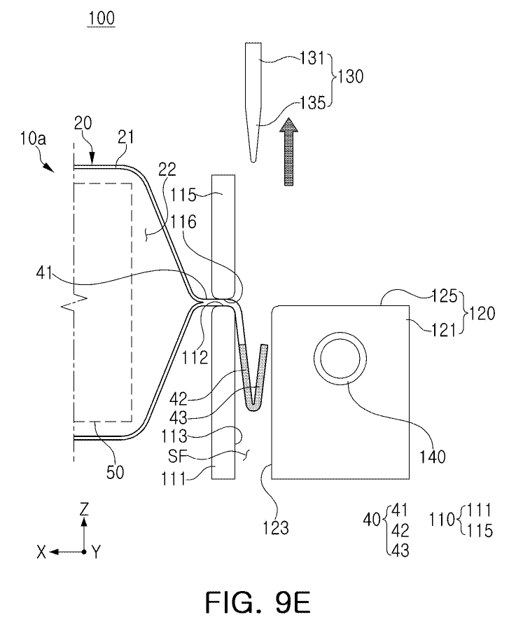

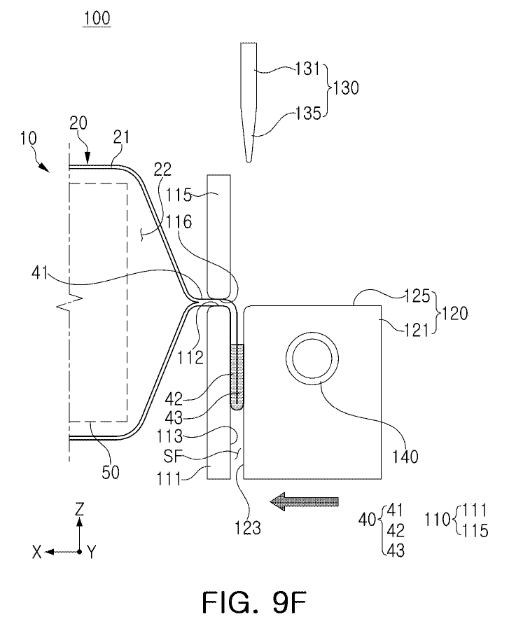

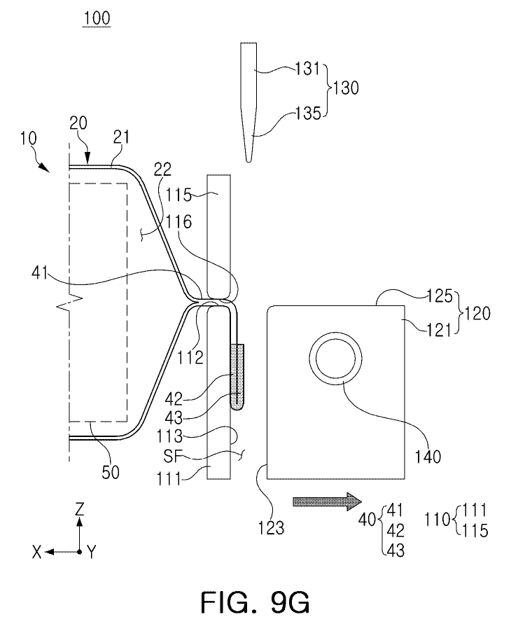

A total angle at which the terrace 25 is folded by the upper mold 130 may be 180 degrees or more. This configuration is described with reference to FIGS. 9A through 9G.

The driving unit 150 may include a first stripper driving unit 151 for moving the lower stripper 111 in the second direction Z, which is the thickness direction of the cell case 20, and a second stripper driving unit 152 for moving the upper stripper 115 in the second direction Z. In the present disclosure, the second direction Z may be defined as a direction parallel to the thickness direction of the cell case 20. The second direction Z may also be defined as a direction perpendicular to the terrace 25 before the folding processing is performed. In addition, in the present disclosure, the second direction Z may be defined to include both +Z-axis and −Z-axis directions relative to the coordinate axis.

The first stripper driving unit 151 and the second stripper driving unit 152 may drive the upper stripper 115 and the lower stripper 111 to allow the upper stripper 115 and the lower stripper 111 to approach or move away from the terrace 25.

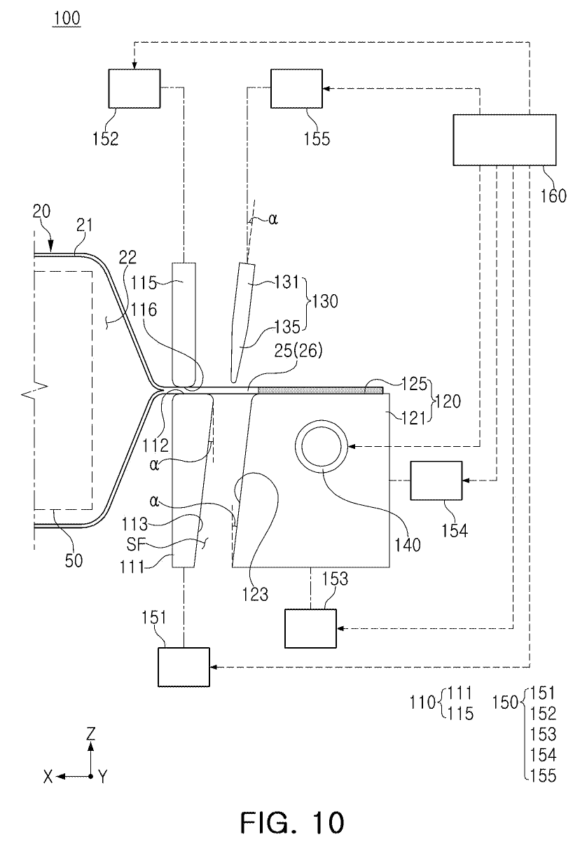

The driving unit 150 may include a folding driving unit 155 for moving the upper mold 130 to enter the folding space SF formed between the lower mold 120 and the lower stripper 111. The folding driving unit 155 may drive the upper mold 130 to enter or exit the folding space SF. The folding driving unit 155 may drive the upper mold 130 to move in the second direction Z, which is the thickness direction of the cell case 20. However, a moving direction of the upper mold 130 is not limited thereto, and the upper mold 130 may also move in a direction inclined relative to the second direction Z, which is the thickness direction of the cell case 20 (see FIG. 10). In this case, the folding driving unit 155 may move the upper mold 130 in the direction inclined relative to the second direction Z.

The lower mold 120 may be structured to move toward the lower stripper 111 to press the folded portion 40 formed on the terrace 25 by the upper mold 130.

The folded portion 40 formed on the terrace 25 by the upper mold 130 may have a gap formed between the second portion 42 and the third portion 43 (see FIG. 9E). The lower mold 120 may move toward the lower stripper 111 to press the folded portion 40 in the open state. When the folded portion 40 is pressed by the lower mold 120, the folded portion 40 may not only have a predetermined angle but also be prevented or restricted from deformation due to the spring-back phenomenon.

The terrace 25 may extend from the electrode accommodating portion 21 of the cell case 20 in the first direction X, and the lower mold 120 may be structured to move in the first direction X to press the folded portion 40. In the present disclosure, the first direction X may be defined as a direction in which the first terrace 26 positioned on the surface where the electrode lead 60 is not disposed extends from the electrode accommodating portion 21. The lower mold 120 may move in the first direction X to press the folded portion 40 in the open state.

The driving unit 150 may include a pressing driving unit 154 for moving the lower mold 120 toward or away from the lower stripper 111 in the first direction X. The pressing driving unit 154 may drive the lower mold 120 to move toward or away from the lower stripper 111.

The driving unit 150 may include a vertical driving unit 153 for moving the lower mold 120 in the first direction X. The driving unit 150 may adjust a height of the lower mold 120 to control a position of the support surface 125 on which the terrace 25 is disposed. However, when the height of the lower mold 120 is fixed, the vertical driving unit 153 may not be installed.

The folding apparatus 100 for a terrace according to an embodiment may further include a heater 140 for heating the lower mold 120.

The heater 140 may increase a temperature of the lower mold 120 to facilitate the deformation of the folded portion 40 when the folded portion 40 is pressed by the lower mold 120. When the lower mold 120 is heated by the heater 140, the folded portion 40 may be restricted or prevented from being opened due to the spring-back phenomenon.

In addition, when the lower mold 120 is heated, a temperature of the terrace 25 disposed on the support surface 125 of the lower mold 120 may increase, thus facilitating the deformation of the terrace 25 when the terrace 25 is folded by the upper mold 130.

For example, the heater 140 may be disposed inside the body 121 of the lower mold 120, and is not limited thereto.

The heater 140 may also be disposed not only in the lower mold 120 but also in the upper mold 130. When a temperature of the upper mold 130 increases, the temperature of the terrace 25 in contact with the upper mold 130 may increase, thus allowing the terrace 25 to be easily folded by the upper mold 130.

The folding apparatus 100 for a terrace according to an embodiment may further include a controller 160. The controller 160 may control driving of the driving unit 150 and driving of the heater 140.

The controller 160 may control driving of the first stripper driving unit 151 and the second stripper driving unit 152 to cause the upper stripper 115 and lower stripper 111 to approach or move away from the terrace 25. The controller 160 may control driving of the pressing driving unit 154 to cause the lower mold 120 to move toward or away from the lower stripper 111. The controller 160 may drive the vertical driving unit 153 to adjust the height of the lower mold 120.

FIGS. 9A through 9G are schematic views sequentially illustrating a process of folding the terrace 25 by using the folding apparatus 100 for a terrace illustrated in FIG. 8. For convenience and clarity of illustration, the driving unit 150 illustrated in FIG. 8 is omitted from FIGS. 9A through 9G.

Referring to FIG. 9A, the terrace 25 of the cell 10a for folding may be disposed on the support surface 125 of the lower mold 120. The first terrace 26 may be disposed on the support surface 125 of the lower mold 120.

Referring to FIG. 9B, to fix a position of the terrace 25 during the folding processing, both the upper and lower sides of the terrace 25 may be fixed by the stripper 110. The lower stripper 111 and the upper stripper 115 may move toward the terrace 25 and press both the sides of the terrace 25.

As illustrated in FIG. 9C, the upper mold 130 may be moved toward the folding space SF. Before entering the folding space SF, the upper mold 130 may come into contact with the terrace 25 positioned above the folding space SF.

Referring to FIG. 9D, the upper mold 130 may enter the folding space SF by moving in the second direction Z, which is the thickness direction of the cell case 20. When the upper mold 130 enters the folding space SF, the terrace 25 may be pressed by the upper mold 130 and folded while coming into contact with the first side surface 113 of the lower stripper 111 and the second side surface 123 of the lower mold 120 forming sides of the folding space SF. FIG. 9D illustrates the upper mold 130 disposed at a position spaced apart from the folded portion 40 to clearly illustrate a shape of the folded portion 40 formed by the upper mold 130.

Accordingly, the folded portion 40 may be formed on the terrace 25 by the upper mold 130. A total folded (bent) angle of the terrace 25 folded by the upper mold 130 may be 180 degrees or more. As the terrace 25 moves into the folding space SF, the folded portion 40 including the first portion 41, the second portion 42, and the third portion 43 may be formed on the terrace 25. An angle at which the second portion 42 is bent relative to the first portion 41 may be approximately 80 degrees, and an angle at which the third portion 43 is bent relative to the second portion 42 may be approximately 170 degrees. In this case, an inner angle between the first portion 41 and the second portion 42 may be approximately 100 degrees, and an inner angle between the second portion 42 and the third portion 43 may be approximately 170 degrees. In this way, as the upper mold 130 enters the folding space SF, the first portion 41, the second portion 42, and the third portion 43 may be simultaneously formed, and the total folded (bent) angle at which the second portion 42 and the third portion 41 are bent relative to the first portion 41 and the second portion 42, respectively, may be 180 degrees or more (e.g., approximately 250 degrees). Accordingly, the folded portion 40 bent twice may be formed by a single process of moving the upper mold 130.

The shape of the folded portion 40 formed by the upper mold 130 in the folding space SF may correspond to a shape of the folding forming portion 135. For example, when the folding forming portion 135 has a shape whose width becomes narrower toward the lower side, the gap between the second portion 42 and the third portion 43 of the folded portion 40 may become narrower toward the lower side. However, the shape of the folding forming portion 135 and the shape of the folded portion 40 primarily formed thereby may be variously modified.

As illustrated in FIG. 9E, when the folded portion 40 is formed on the terrace 25 by the upper mold 130, the upper mold 130 may be moved outward from the folding space SF.

As illustrated in FIG. 9F, the lower mold 120 may move toward the lower stripper 111 to press the folded portion 40 formed on the terrace 25 by the upper mold 130. For example, the lower mold 120 may move in the first direction X to press the folded portion 40. When the folded portion 40 is pressed by the lower mold 120, the folded portion 40 may not only have a predetermined angle but also be prevented or restricted from deformation due to the spring-back phenomenon. The lower mold 120 may press the folded portion 40 while being heated by the heater 140.

When pressed by the lower mold 120, the terrace 25 may have the folded portion 40 including the first portion 41, the second portion 42, and the third portion 43. The folded portion 40 may have the third portion 43 disposed outside the second portion 42.

Next, as illustrated in FIG. 9G, the lower mold 120 may move away from the lower stripper 111. The lower stripper 111 and the upper stripper 115 may then move away from the terrace 25. Accordingly, formation of the folded portion 40 may be completed.

The folded portion 40 illustrated in FIG. 9G may have an angle of approximately 90 degrees between the first portion 41 and the second portion 42, and an angle of approximately 180 degrees between the second portion 42 and the third portion 43.

Meanwhile, a sizing process may be additionally performed in a state where the angle between the first portion 41 and the second portion 42 is 90 degrees. The sizing process refers to a process of pressing an end of the folded portion 40 toward the electrode accommodating portion 21 of the cell case 20. When the sizing process is performed, the first angle θ between the first portion 41 and the second portion 42 may have a value less than 90 degrees, as illustrated in FIG. 5. When the sizing process is performed, the folded portion 40 may be prevented from being unfolded due to the spring-back phenomenon.

FIG. 10 is a schematic view of the folding apparatus 100 for a terrace according to another embodiment.

Compared with the folding apparatus 100 for a terrace illustrated in FIG. 8, the folding apparatus 100 for a terrace illustrated in FIG. 10 differs in that the upper mold 130 moves in the direction inclined relative to the second direction Z, and that the first side surface 113 of the lower stripper 111 and the second side surface 123 of the lower mold 120 include inclined surfaces. Except for the differences, the descriptions provided with reference to FIGS. 8 through 9G may also be applied to FIG. 10.

The folding apparatus 100 for a terrace illustrated in FIG. 10 may include the stripper 110, the lower mold 120, and the upper mold 130. The stripper 110 may include the upper stripper 115 and the lower stripper 111 disposed to face each other to support the terrace 25 of the cell case 20 from both the sides. The folding apparatus 100 for a terrace may further include the driving unit 150 for moving at least some of the lower mold 120, the upper mold 130, the upper stripper 115, and the lower stripper 111. The folding apparatus 100 for a terrace may further include the heater 140 for heating the lower mold 120.

The upper mold 130 may be structured to enter the folding space SF by moving in the direction inclined relative to the second direction Z, which is the thickness direction of the cell case 20. That is, the upper mold 130 may enter the folding space SF in the direction inclined relative to the second direction Z, than in the second direction Z perpendicular to the terrace 25.

The moving direction of the upper mold 130 may form a predetermined inclination angle α relative to the second direction Z. The inclination angle α formed by the moving direction of the upper mold 130 may be inclined toward the electrode accommodating portion 21 as the inclination angle α goes downward.

The first side surface 113 of the lower stripper 111 and the second side surface 123 of the lower mold 120, which face each other, may respectively include inclined surfaces inclined relative to the second direction Z. At least one of the inclination angle α of the first side surface 113 of the lower stripper 111 and the inclination angle α of the second side surface 123 of the lower mold 120 may have the same value as the inclination angle α formed by the moving direction of the upper mold 130. For example, the inclination angles α of the first side surface 113 of the lower stripper 111 and the second side surface 123 of the lower mold 120 may respectively have the same value as the inclination angle α formed by the moving direction of the upper mold 130.

When the upper mold 130 moves at the inclination angle α relative to the second direction Z, the folded portion 40 of the battery cell 10 illustrated in FIG. 5 may be formed. That is, the folded portion 40 of the battery cell 10 manufactured by the folding apparatus 100 for a terrace illustrated in FIG. 10 may have the first angle θ between the first portion 41 and the second portion 42 that is less than 90 degrees. Accordingly, in the folding apparatus 100 for a terrace illustrated in FIG. 10, the folded portion 40 having the first angle θ less than 90 degrees between the first portion 41 and the second portion 42 may be formed even without additionally performing the sizing process.

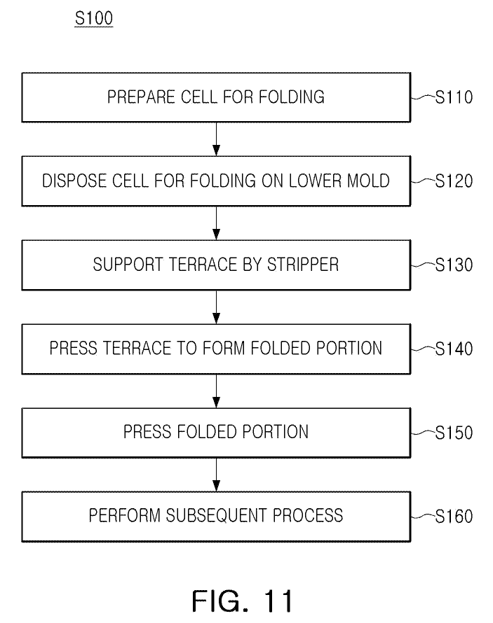

FIG. 11 is a flowchart illustrating a manufacturing method of a battery cell (S100) according to an embodiment.

Referring to FIG. 11, the manufacturing method of a battery cell (S100) according to an embodiment of the present disclosure may include: preparing a cell 10a for folding including a sealing portion 30 formed on a terrace 25 (S110); disposing the terrace 25 of the cell 10a for folding on a lower mold 120 (S120), supporting both sides of the terrace 25 by a lower stripper 111 and an upper stripper 115 (S130); and performing a folding process of pressing the terrace 25 by using an upper mold 130 to form a folded portion 40 on the terrace 25 (S140). In the folding process (S140), the terrace 25 may be folded by causing the upper mold 130 to enter a folding space SF formed between the lower mold 120 and the lower stripper 111.

The manufacturing method of a battery cell (S100) according to an embodiment may further include performing a pressing process of moving the lower mold 120 toward the lower stripper 111 to press the folded portion 40 formed on the terrace 25 (S150).

The manufacturing method of a battery cell (S100) is described in more detail with reference to FIGS. 1 through 4 and 9A through 9G together with FIG. 11.

Referring to FIG. 2, in the preparing of the cell 10a for folding (S110), the cell 10a for folding having the flat terrace 25 as illustrated in FIGS. 1 and 2 may be prepared. The cell 10a for folding may include an electrode assembly 50, an electrode lead 60, and a cell case 20. The cell case 20 may include an electrode accommodating portion 21 accommodating the electrode assembly 50 and a terrace 25 disposed on at least a portion of a circumference of the electrode accommodating portion 21. The terrace 25 may include a first terrace 26 positioned on a surface where the electrode lead 60 is not disposed. At least a partial region of the terrace 25 may be thermally fused (pressed) to form the sealing portion 30. The sealing portion 30 may include a first sealing portion 31 formed on the first terrace 26 where the electrode lead 60 is not disposed.

Referring to FIG. 9A, the disposing of the terrace 25 on the lower mold 120 (S120) refers to a process of disposing the terrace 25 of the cell 10a for folding on the support surface 125 of the lower mold 120. The first terrace 26 may be disposed on the support surface 125 of the lower mold 120.

Referring to FIG. 9B, the supporting of both the sides of the terrace 25 (S130) refers to a process of supporting both the upper and lower sides of the terrace 25 by the stripper 110 to fix a position of the terrace 25 during a folding processing. The stripper 110 may include a lower stripper 111 and an upper stripper 115. The lower stripper 111 and the upper stripper 115 may move toward the terrace 25 and press both the sides of the terrace 25.

Referring to FIGS. 9C to 9E, the folding process (S140) refers to a process of pressing the terrace 25 by using the upper mold 130 to form the folded portion 40 on the terrace 25.

Before entering the folding space SF, the upper mold 130 may come into contact with the terrace 25 positioned above the folding space SF. When the upper mold 130 enters the folding space SF, the terrace 25 may be pressed by the upper mold 130 and folded while coming into contact with a first side surface 113 of the lower stripper 111 and a second side surface 123 of the lower mold 120 forming sides of the folding space SF. Accordingly, as illustrated in FIG. 9E, the folded portion 40 may be formed on the terrace 25 by the upper mold 130. The folded portion 40 formed by the upper mold 130 may include a first portion 41, a second portion 42, and a third portion 43. The folded portion 40 bent twice may be formed by a single process. Therefore, according to an embodiment, a process of forming the folded portion 40 on the terrace 25 may be simplified, and productivity may be improved.

As illustrated in FIG. 9C, in the folding process (S140), the upper mold 130 may enter the folding space SF by moving in a second direction Z, which is a thickness direction of the cell 10a for folding. Accordingly, the folded portion 40 having a shape illustrated in FIG. 4 may be formed on the terrace 25. For example, the folded portion 40 having a first angle θ of 90 degrees between the first portion 41 and the second portion 42 may be formed.

Alternatively, as illustrated in FIG. 10, in the folding process (S140), the upper mold 130 may enter the folding space SF by moving in a direction inclined relative to the second direction Z, which is the thickness direction of the cell 10a for folding. Accordingly, the folded portion 40 having a shape illustrated in FIG. 5 may be formed on the terrace 25. For example, the folded portion 40 having a first angle θ between the first portion 41 and the second portion 42 that is less than 90 degrees may be formed.

As illustrated in FIG. 9E, when the folded portion 40 is formed on the terrace 25 by the upper mold 130, the upper mold 130 may be moved outward from the folding space SF.

Referring to FIG. 9F, the pressing process (S150) refers to a process of moving the lower mold 120 toward the lower stripper 111 to press the folded portion 40 formed on the terrace 25.

For example, the lower mold 120 may move in a first direction X to press the folded portion 40. When the folded portion 40 is pressed by the lower mold 120, the folded portion 40 may not only have a predetermined angle but also be prevented or restricted from deformation due to a spring-back phenomenon. The lower mold 120 may press the folded portion 40 while being heated by a heater 140.

The pressing process (S150) may be performed while the lower mold 120 is heated. If the lower mold 120 is heated, the deformation of the folded portion 40 may be facilitated when the folded portion 40 is pressed by the lower mold 120. When the lower mold 120 is heated, the folded portion 40 may be restricted or prevented from being opened due to the spring-back phenomenon.

After formation of the folded portion 40 is completed through the pressing process (S150), as illustrated in FIG. 9G, the lower mold 120 may be moved in a direction away from the lower stripper 111. In addition, the lower stripper 111 and the upper stripper 115 may be moved in directions away from the terrace 25. Accordingly, the formation of the folded portion 40 may be completed, and the battery cell 10 may be separated from the folding apparatus 100 for a terrace.

Meanwhile, the manufacturing method of a battery cell (S100) according to an embodiment may further include performing a subsequent process on the folded portion 40 (S160) after the pressing process (S150).

For example, the subsequent process may include a sizing process. The sizing process refers to a process of pressing an end of the folded portion 40 toward the electrode accommodating portion 21 of the cell case 20. When the sizing process is performed, as illustrated in FIG. 5, the first angle θ between the first portion 41 and the second portion 42 may have a value less than 90 degrees.

In addition, the subsequent process may include a process of attaching a tape to the folded portion 40 to prevent the folded portion 40 from being unfolded due to the spring-back phenomenon.

As set forth above, according to an embodiment of the present disclosure, the process of forming the folded portion on a terrace may be simplified and the productivity may be improved.

According to an embodiment of the present disclosure, the folded portion may be easily formed on the terrace.

According to an embodiment of the present disclosure, the equipment for the folding processing may be simplified, and the equipment cost may be reduced.

Only specific examples of implementations of certain embodiments are described. Variations, improvements and enhancements of the disclosed embodiments and other embodiments may be made based on the disclosure of this patent document.

What is claimed is:

1. A folding apparatus for a terrace of a cell case, the apparatus comprising:
a stripper including an upper stripper and a lower stripper disposed to face each other to support both sides of the terrace of the cell case;
a lower mold for supporting the terrace; and
an upper mold for folding the terrace to form a folded portion on the terrace,
wherein the upper mold enters a folding space formed between the lower mold and the lower stripper to fold the terrace.

2. The apparatus of claim 1, wherein the lower mold is structured to move toward the lower stripper to press the folded portion formed on the terrace by the upper mold.

3. The apparatus of claim 2, wherein the terrace extends from an electrode accommodating portion of the cell case in a first direction, and
the lower mold is structured to move in the first direction to press the folded portion.

4. The apparatus of claim 1, wherein a total angle of the terrace folded by the upper mold is 180 degrees or more.

5. The apparatus of claim 1, wherein the upper mold includes a folding forming portion in contact with the terrace for folding the terrace, and
the folding forming portion has a shape whose width becomes narrower toward a lower side.

6. The apparatus of claim 1, wherein the upper mold is structured to enter the folding space by moving in a second direction, which is a thickness direction of the cell case.

7. The apparatus of claim 1, wherein the upper mold is structured to enter the folding space by moving in a direction inclined relative to a second direction, which is a thickness direction of the cell case.

8. The apparatus of claim 7, wherein a first side surface of the lower stripper and a second side surface of the lower mold, which face each other, respectively include inclined surfaces inclined relative to the second direction, and
at least one of an inclination angle of the first side surface of the lower stripper and an inclination angle of the second side surface of the lower mold has the same value as an inclination angle formed by a moving direction of the upper mold.

9. The apparatus of claim 1, further comprising:
a heater for heating the lower mold.

10. A manufacturing method of a battery cell, the method comprising:
preparing a cell for folding including a sealing portion formed on a terrace;
disposing the terrace of the cell for folding on a lower mold;
supporting both sides of the terrace by a lower stripper and an upper stripper; and
performing a folding process of pressing the terrace by using an upper mold to form a folded portion on the terrace,
wherein in the folding process, the terrace is folded by causing the upper mold to enter a folding space formed between the lower mold and the lower stripper.

11. The method of claim 10, further comprising:
a pressing process of moving the lower mold toward the lower stripper to press the folded portion formed on the terrace.

12. The method of claim 10, wherein in the folding process, the upper mold enters the folding space by moving in a second direction, which is a thickness direction of the cell for folding.

13. The method of claim 10, wherein in the folding process, the upper mold enters the folding space by moving in a direction inclined relative to a second direction, which is a thickness direction of the cell for folding.

14. The method of claim 11, wherein the pressing process is performed while the lower mold is heated.

15. A battery cell comprising:
an electrode assembly; and
a cell case including an electrode accommodating portion accommodating the electrode assembly and a terrace disposed on at least a portion of a circumference of the electrode accommodating portion and extending outwardly from the electrode accommodating portion,
wherein at least a portion of the terrace includes a folded portion,
the folded portion includes a first portion in which the terrace extends from the electrode accommodating portion in a first direction, a second portion connected to the first portion and bent to form a first angle relative to the first portion, and a third portion connected to the second portion and bent to form a second angle relative to the second portion, and
the third portion is disposed outside the second portion.

16. The battery cell of claim 15, wherein the first angle has a value of 75 degrees or more and 105 degrees or less.

17. The battery cell of claim 15, wherein the second angle has a value of 150 degrees or more and 180 degrees or less.

18. The battery cell of claim 15, wherein a length of the third portion is greater than a length of the second portion.
